(19) United States
(12) Patent Application Publication
(10) Pub. No.: US 2014/0065519 A1
(43) Pub. Date: Mar. 6, 2014

(54) METHOD FOR FABRICATING A FUEL CELL INCLUDING A MEMBRANE-ELECTRODE ASSEMBLY

(71) Applicant: Commissariat à I'énergie atomique et aux énergies alternatives, Paris (FR)

(72) Inventors: Remi Vincent, Grenoble (FR); Benoit Barthe, Chindrieux (FR); Denis Tremblay, Pommiers-La-Placette (FR)

(73) Assignee: Commissariat à I'énergie atomique et aux énergies alternatives, Paris (FR)

(21) Appl. No.: 14/016,643

(22) Filed: Sep. 3, 2013

(30) Foreign Application Priority Data
Sep. 3, 2012 (FR) 1258197

(51) Int. Cl. H01M 8/10

(52) U.S. Cl. CPC H01M 8/1004
USPC 429/535

(57) ABSTRACT

A method for fabricating a fuel cell includes fixedly attaching a reinforcement to a proton-exchange membrane and to an electrode placed against a first face of the proton-exchange membrane. The reinforcement has a median aperture through which an interior portion of the electrode is exposed. Fixedly attaching the reinforcement includes superimposing an inner edge of the reinforcement over a periphery of the electrode, and causing a projecting portion of the reinforcement to project the proton-exchange membrane so as to limit gas permeation into the proton-exchange membrane, and forming filigrees by a wet process in a gas diffusion layer, thereby forming a recess therein, and placing the gas diffusion layer so that the inner edge of the reinforcement extends into the recess in the gas diffusion layer.

### RELATED APPLICATIONS

Under 35 USC 119, this application claims the benefit of the priority date of French application FR 1258197 filed on Sep. 3, 2012, the content of which is herein incorporated by reference.

### FIELD OF THE DISCLOSURE

The invention pertains to proton-exchange membrane fuel cells, and in particular, to methods for fabricating fuel cells.

### BACKGROUND

Fuel cells are envisaged as an electric power supply system for future mass-produced motor vehicles as well as for a large number of applications. A fuel cell is an electrochemical device that converts chemical energy directly into electrical energy. Hydrogen (H2) or molecular hydrogen is used as a fuel for the fuel cell. The hydrogen gas is oxidized and ionized on an electrode of the cell and oxygen (O2) or molecular oxygen from the air is reduced on another electrode of the cell. The chemical reaction produces water at the cathode, oxygen being reduced and reacting with the protons. The great advantage of the fuel cell is that it averts rejection of atmospheric pollutant compounds at the place where electricity is generated.

Proton exchange membrane (PEM) fuel cells have particularly interesting properties of compactness. Each cell has an electrolytic membrane enabling only the passage of protons and not the passage of electrons. The membrane comprises an anode on a first face and a cathode on a second face to form a membrane-electrode assembly known as an MEA.

At the anode, the hydrogen (H2) is ionized to produce protons passing through the membrane. The electrons produced by this reaction migrate to a flow plate and then pass through an electrical circuit external to the cell to form an electrical current.

The fuel cell can comprise several flow plates, for example made of metal, stacked on one another. The membrane is positioned between two flow plates. The flow plates can comprise channels and holes to guide the reactants and products to and from the membrane. The plates are also electrically conductive so as to form collectors for the electrons generated at the anode.

Gas diffusion layers are interposed between the electrodes and the flow plates and are in contact with the flow plates.

The methods for assembling the fuel cell and especially the methods for fabricating the MEA are of decisive importance for the performance characteristics of the fuel cell and its service life.

A known method for fabricating membrane electrode assemblies is currently being favored in order to obtain an optimal compromise between the performance of the MEA and its service life. This method comprises a preliminary step for printing a layer of electrocatalyst ink on a smooth and hydrophobic support, insensitive to the solvents present in the ink. The printing support especially has a very small surface energy and very low roughness. After the formation of an electrode by the drying of the electrocatalyst ink, the electrode is joined with the membrane by hot-pressing. Owing to the low adhesion of the electrode to the printing support, this hot-pressing can be done under reduced temperature and pressure. The deterioration of the membrane during the hot-pressing step is thus reduced. Moreover, the electrode formed by printing on a smooth support has homogenous thickness and composition, thus also limiting the deterioration of the membrane during the hot-pressing. Moreover, since the electrode is joined with the membrane after drying, the membrane is not placed in contact with the solvents of the ink and does not undergo any corresponding deterioration.

The document US2008/0105354 describes a method of this kind for assembling membranes/electrodes on a fuel cell. The membrane/electrode assembly formed comprises reinforcements or subgaskets. Each reinforcement surrounds the electrodes. The reinforcements are formed out of polymer films and reinforce the membrane/electrode assembly at the gas and cooling liquid inlets. The reinforcements facilitate the handling of the membrane/electrode assembly to prevent its deterioration. The reinforcements also limit the dimensional variations of the membrane according to temperature and humidity. In practice, the reinforcements are superimposed on the periphery of the electrodes in order to limit the phenomenon of gas permeation which is the source of deterioration of the membrane/electrode assembly.

According to this method, a reinforcement is made by forming an aperture in the median part of a polymer film. The reinforcement comprises a pressure-sensitive adhesive on one face. A membrane/electrode assembly is recovered and the aperture of the reinforcement is positioned so as to be plumb with an electrode. The reinforcement covers the periphery of this electrode. A pressing is then done to fixedly attach the reinforcement with the membrane and the edge of the electrode by means of the adhesive. Cut-outs are then made in the reinforcement to form the inlets of gas and liquid.

Gas diffusion layers are then placed in contact with the uncovered part of the electrodes. A hot-pressing operation is frequently performed to favor contact between a gas diffusion layer and its electrode. The periphery of each gas diffusion layer covers at least a part of a respective reinforcement in order to limit direct shear forces on the membrane. Locally, the superimposition of an electrode, a reinforcement and a gas diffusion layer induces excess thickness. During a hot-pressing step, this zone undergoes higher local pressure, potentially the source of deterioration, especially on the membrane, leading to a diminishing of the service life of the fuel cell. The non-homogeneity of the pressure during the hot-pressing can additionally cause gaps between the reinforcement, the gas diffusion layer and the electrode, and cause deterioration in the performance of the fuel cell.

When designing a fuel cell, an increase of its power is generally obtained either by increasing the number of stacked electrochemical cells, or by increasing the surface of the membrane/electrodes assemblies and of the bipolar plates. Such a design increases in the same proportion the weight and the dimensions of the fuel cell, as well as the volume and the cost of the gas diffusion layer. In numerous applications, the dimensions and the weight of a fuel cell are strongly limited.

### SUMMARY

The invention seeks to resolve one or more of the foregoing drawbacks.

In one aspect, the invention features a method for fabricating a fuel cell. Such a method includes fixedly attaching a reinforcement to a proton-exchange membrane and to an electrode placed against a first face of the proton-exchange membrane. The reinforcement has a median aperture through which an interior portion of the electrode is exposed. Fixedly attaching the reinforcement includes superimposing an inner edge of the reinforcement over a periphery of the electrode, and causing a projecting portion of the reinforcement to project the proton-exchange membrane so as to limit gas permeation into the proton-exchange membrane, and forming filigrees by a wet process in a gas diffusion layer, thereby forming a recess therein, and placing the gas diffusion layer so that the inner edge of the reinforcement extends into the recess in the gas diffusion layer.

In some practices of the invention, forming filigrees includes applying layer of an aqueous solution including carbon fibers and a binding material, and solidifying components of the aqueous solution to form the gas diffusion layer. Among these practices are those in which the gas diffusion layer formed includes a recess having a depth between 25 μm and 75 μm, and those in which the gas diffusion layer formed includes a recess having a width between 500 μm and 3000 μm.

In other practices, the gas diffusion layer placed has a substantially homogenous composition.

In yet other practices, the gas diffusion layer includes a first face, in which the recess is formed, and a second face, wherein a part of the second face that is disposed over the recess is in alignment with a median part of the second face.

Another aspect of the invention features a method for fabricating a fuel cell. Such a method includes fixedly attaching a reinforcement having an aperture in a median part thereof, to a proton-exchange membrane and to an electrode placed against one face of the proton-exchange membrane, so that an inner edge of the fixedly attached reinforcement covers a periphery of the electrode, with a projection onto the proton-exchange membrane, forming a recess on a periphery of a gas diffusion layer by forming filigrees by a wet process in the gas diffusion layer, and placing the gas diffusion layer so that the recess is positioned plumb with the inner edge of the reinforcement.

In some practices, forming filigrees includes applying layer of an aqueous solution including carbon fibers and a binding material, and solidifying components of the aqueous solution to form the gas diffusion layer. Among these practices are those in which the gas diffusion layer formed includes a recess having a depth between 25 μm and 75 μm and also those in which the gas diffusion layer formed includes a recess having a width between 500 μm and 3000 μm.

In some practices, the gas diffusion layer placed has a substantially homogenous composition.

In other practices, the gas diffusion layer includes a first face, in which the recess is formed, and a second face, wherein a part of the second face that is plumb with the recess is in the alignment with a median part of the second face.

### BRIEF DESCRIPTION OF THE DRAWINGS

Other features and advantages of the invention shall appear more clearly from the following description, given by way of an indication that is in no way exhaustive, with reference to the appended drawings, of which:

FIG. 1 is a schematic view in cross-section of an example of a fuel cell;

FIG. 2 is a view in cross-section of the periphery of a membrane/electrode assembly devoid of the gas diffusion layer;

FIG. 3 is a view in section of the periphery of a gas diffusion layer which can be integrated into a fuel cell;

FIGS. 4 to 10 illustrate different steps of an example of a method for fabricating a fuel cell according to the invention;

FIG. 11 is a schematic view in cross-section of an example of a fuel cell focusing on its membrane/electrodes assembly;

FIG. 12 is a view in cross-section of an interface between several electrochemical cells;

FIG. 13 is a view in cross-section of a gas diffusion layer during another method for fabricating a fuel cell;

FIG. 14 is a top view of the method step of FIG. 13.

### DETAILED DESCRIPTION

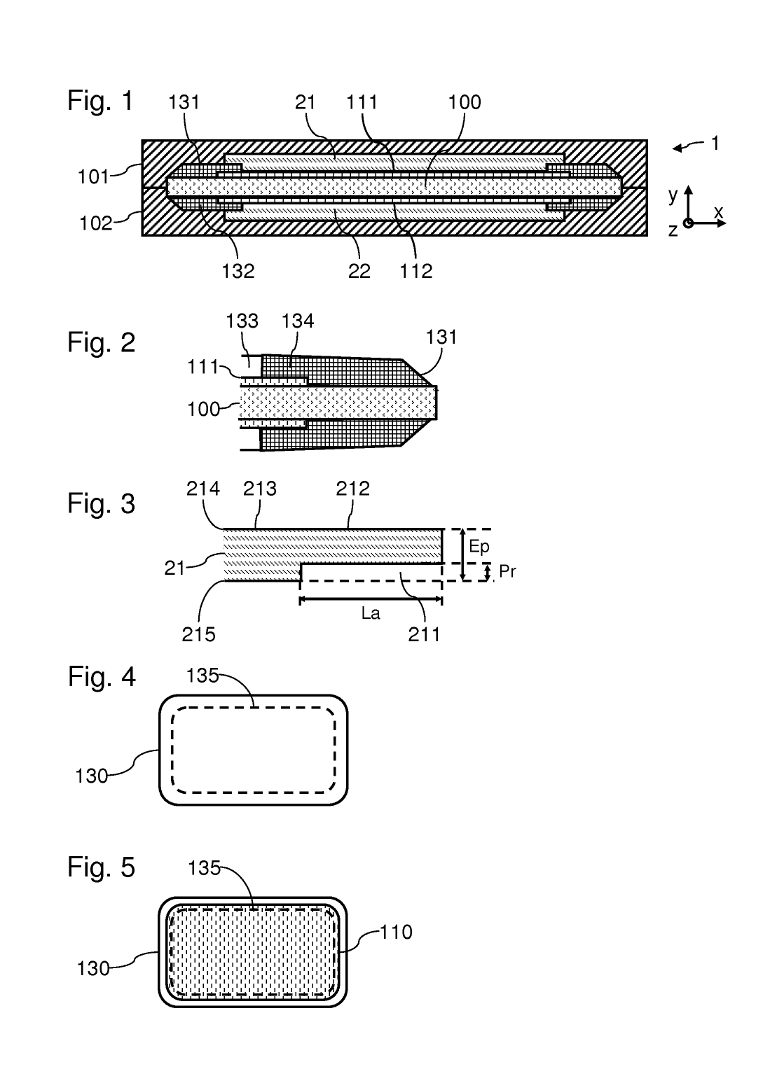

FIG. 1 is a view in section of an example of a fuel cell 1 including a membrane/electrode assembly fabricated according to an example of a method according to the invention. The fuel cell 1 is of the proton exchange membrane or polymer electrolyte membrane type. Although this is not illustrated, the fuel cell can comprise several superimposed electrochemical cells. The fuel cell 1 comprises a motor fuel source feeding an inlet of each cell with hydrogen (H2) from the air. The fuel cell 1 also has an air source feeding an inlet of each cell with air, containing oxygen used as an oxidant. Each cell also comprises exhaust channels. Each cell can also have a cooling circuit known per se.

Each cell comprises a membrane/electrode assembly or MEA. Each membrane/electrode assembly comprises a layer of electrolyte formed for example by a polymer membrane 100.

The membrane/electrode assembly also comprises a cathode 111 and an anode 112 placed on either side of the membrane 100. The cathode 111 and the anode 112 are advantageously fixed to this membrane 100 by any appropriate means (for example hot-pressing).

The electrolyte layer forms a semi-permeable membrane 100 enabling proton conduction while at the same time being impermeable to the gases present in the cell. The membrane 100 also prevents a passage of electrons between the anode 112 and the cathode 111.

The fuel cell 1 further comprises reinforcements or subgaskets 131 and 132 positioned on the periphery respectively of the cathode 111 and the anode 112. The reinforcements 131 and 132 are superimposed on the periphery of the electrodes with a projection over the membrane 100 in order to limit the phenomenon of gas permeation which causes deterioration in the membrane/electrode assembly. The reinforcements 131 and 132 are typically formed by polymer films and reinforce the membrane/electrode assembly at the gas and cooling liquid inlets. The reinforcements 131 and 132 also facilitate the handling of the membrane/electrode assembly to prevent its deterioration. The reinforcements 131 and 132 also limit dimensional variations in the membrane 100 as a function of temperature and humidity.

Each cell has flow-guiding plates 101 and 102, positioned so as to respectively face the cathode 111 and the anode 112. Each cell has a gas diffusion layer 21 positioned between the cathode 111 and the guiding plate 101. Each cell furthermore has a gas diffusion layer 22 positioned between the anode 112 and the guiding plate 102. Two guiding plates for adjacent cells can form one bipolar plate in a manner known per se. The guiding plates can be formed by metal sheets comprising a surface in relief defining flow channels.

Flow channels 103 and 104 are distributed along the z direction and extend according to the x direction, as illustrated at FIG. 12. The stacked electrochemical cells are compressed (as known per se) to make the periphery of the electrochemical cells waterproof, and to press the gas diffusion layers on their respective electrodes and guiding plates.

In a manner known per se, during the operation of the fuel cell 1, air flows between the MEA and the guiding plate 101, and hydrogen (H2) flows between the MEA and the guiding plate 102. At the anode 112, hydrogen (H2) is ionized to produce protons which pass through the MEA. The electrons produced by this reaction are collected at the guiding plate 101. The electrons produced are then applied to an electrical load connected to the fuel cell 1 to form an electric current. At the cathode 111, oxygen is reduced and reacts with the protons to form water. The reactions at the anode and the cathode are controlled as follows:

H₂→2H⁺+2e⁻ at the anode;

4H⁺+4e⁻+O₂→2H₂O at the cathode.

When it is in operation, a cell of the fuel cell usually generates a DC voltage of the order of 1V between the anode and the cathode.

FIG. 2 is a view in section of the periphery of the membrane/electrode assembly of the fuel cell of FIG. 1. For reasons of readability, gas diffusion layers are not illustrated in this view.

The reinforcement 131 shall be described in detail here below. The reinforcement 132 can have a substantially identical structure. The reinforcement 131 has an internal border 134 which covers the periphery of the cathode 111. The covering of the periphery of the cathode 111 by the internal border 134 advantageously extends over a width ranging from 500 to 3000 μm. The internal border 134 is fixedly joined to the cathode 111. The reinforcement 131 extends beyond the periphery of the cathode 111 and forms a projection onto the membrane 100. The reinforcement 131 is fixedly attached to the membrane 100. The fixed attachment of the reinforcement 131 to the cathode 111 and to the membrane 100 can be set up by any appropriate means, for example by hot-pressing or by printing the cathode 111 on the reinforcement 131. The reinforcement 131 has an aperture 133 in its median part. The aperture 133 thus uncovers the median part of the cathode 111.

The reinforcements 131, 132 and the electrodes 111, 112 generally have homogenous thicknesses. Consequently, the overlap between the internal border of a reinforcement and the periphery of an electrode can create a slight local excess thickness. This excess thickness can correspond appreciably to the thickness of the electrode. The electrodes 111 and 112 generally have a thickness ranging from 5 μm to 25 μm. The reinforcements 131 and 132 generally have a thickness ranging from 25 μm to 75 μm.

FIG. 3 is a magnified view in section of the periphery of an example of a gas diffusion layer which can be used on the anode side or the cathode side of a fuel cell 1 according to the invention.

The gas diffusion layer 21 illustrated has two faces 214 and 215. The face 214 is intended for coming into contact with a guiding plate 101. The face 215 is intended for coming into contact with an electrode (the cathode 111 in this case), through the aperture 133 of the reinforcement 131. The gas diffusion layer 21 comprises a recess 211 on its periphery, this recess 211 being prepared in the face 215. The median part of the face 215 thus forms a bulge (relative to the recess 211), passing through the aperture 133 of the reinforcement 131 in order to come into contact with the cathode 111.

The recess 211 is intended to be plumb with the internal border 134 of the reinforcement 131. Thus, a superimposition is created between the internal border 134, in limiting or eliminating the thickness locally formed by this superimposition. To this end, the recess 211 advantageously has a depth Pr ranging from 0.8*Epr to 1.1*Epr, with Epr being the thickness of the reinforcement 131 at its internal border 134. The depth Pr advantageously ranges from 25 μm to 75 μm. The gas diffusion layer 21 advantageously has a thickness Ep ranging from 200 μm to 400 μm at its median part. The thickness of the recess 211 advantageously ranges from 500 μm to 3000 μm. The sizing of the recess 211 is advantageously made so that the internal border 134 does not extend up to the median part of the face 215 or so that the bulge formed gets housed within the aperture 133.

The junction between the recess 211 and the median part of the face 215 can advantageously present a chamfer or a connection radius.

To limit local excess pressure during a hot-pressing step if any, the gas diffusion layer 211 advantageously has a face 214 in which a portion 212 is made to align with a portion 213. The portion 212 corresponds to that part of the face 214 which is plumb with the recess 211. The part 213 corresponds to the median part of the face 214. Thus, the level of the face 214 is appreciably homogenous during a hot-pressing step or during the joining of the plates 101 and 102. Advantageously, the face 214 is substantially plane. Advantageously, the gas diffusion layer 211 has a substantially homogenous composition throughout its surface.

FIGS. 4 to 10 illustrate different steps of the fabrication of a fuel cell 1 according to one example of the method of the invention. The method described with reference to FIGS. 4 to 10 can be implemented on the cathode side 111 and/or the anode side 112.

FIG. 4 is a top view of a supplied support 130. The support 130 is an advantageously plane support. A pre-cut contour 135 can be made in the support 130. The pre-cut contour 135 thus divides the support 130 between a peripheral part and a median part.

FIG. 5 is a top view of the support 130 after the deposition of an electrocatalyst ink in liquid phase, designed to form an electrode 110 after drying. The electrode 110 can be solidified by any appropriate means. The electrode 110 formed extends beyond the pre-cut contour 135. Thus, a superimposition is created between an internal border of the peripheral part and the periphery of the electrode 110.

The electrocatalyst material has catalytic properties suited to the catalytic reaction to be obtained. The electrocatalyst material can take the form of particles or nano-particles including metal atoms. The catalyst material can especially include metal oxides. The electrocatalyst material can be a metal such as platinum, gold, silver, cobalt, ruthenium.

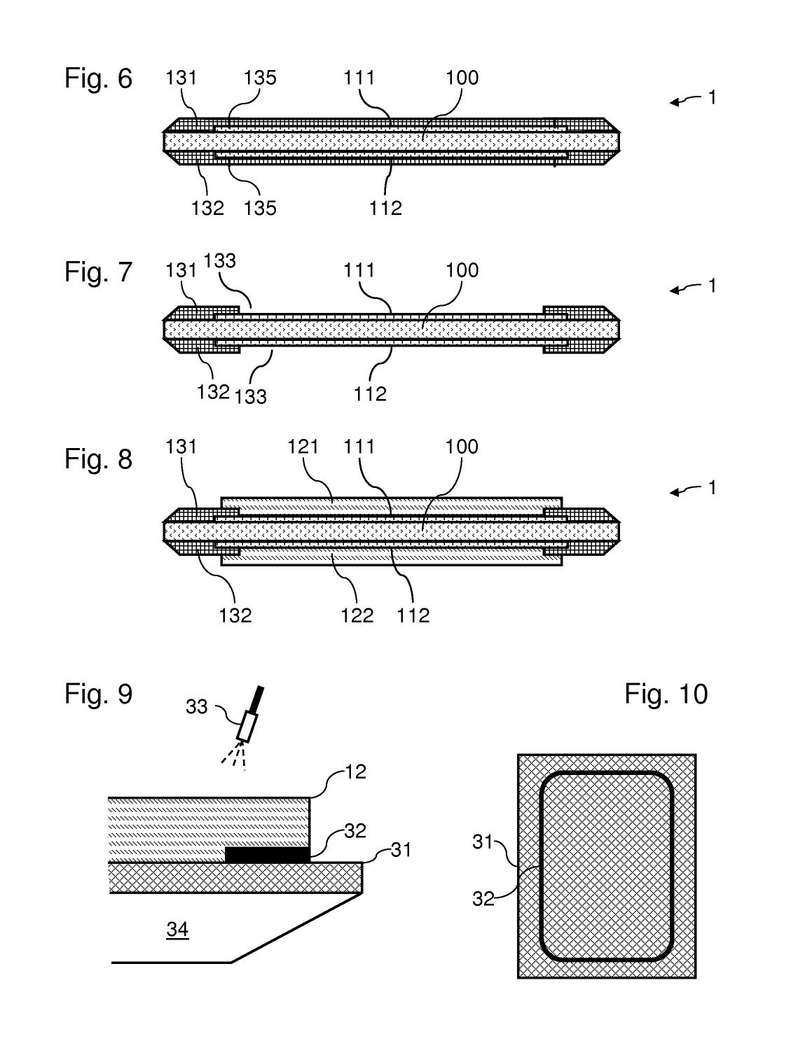

FIG. 6 is a view in section of a cell of a fuel cell 1 formed by using a support (such as the reinforcement 131) and a cathode 111, as well as a support (such as a reinforcement 132) and an anode 112, obtained according to the steps illustrated in FIGS. 4 and 5. At this step of the fabricating process, a membrane/electrode assembly is obtained by fixedly attaching, firstly, the support/reinforcement 131 and the cathode 111 to a face of the membrane 100, and, secondly, the support/reinforcement 132 and the anode 112 to another face of the membrane 100. A reinforcement and an electrode can thus be fixedly attached to the membrane 100 during a same hot-pressing step.

To favor the adhesion of an electrode 110 to the membrane 100 during a hot-pressing step, the membrane 100 and the electrode 110 advantageously comprise a same polymer material. This polymer material advantageously has a glass transition temperature below the hot-pressing temperature. The polymerizable material used to form this polymer material could be the ionomer commercially distributed under the commercial reference Nafion DE2020.

For adhesion by hot-pressing, the hot-pressing temperature advantageously ranges from 100° C. to 130° C., and preferably from 110° C. to 125° C.

FIG. 7 is a view in section of the cell of a fuel cell 1 after the withdrawal (cutting out along the contours 135) of the median part of the reinforcements 131 and 132 respectively so as to prepare their aperture 133. The apertures 133 respectively uncover the median part of the cathode 111 and the median part of the anode 112. Thus, reinforcements can be formed from supports made by deposition of an electrocatalyst ink.

Advantageously, at the end of this withdrawal step, the reinforcements 131 and 132 can be subjected to operations for cutting out through-holes at their periphery, for example to make passages for the flow of gas or cooling liquid.

FIG. 8 is a view in section of the cell of a fuel cell 1 after the positioning of the gas diffusion layers 21 and 22. The gas diffusion layer 21 is thus placed in contact with the uncovered part of the cathode 111 through the aperture 133. The periphery of the gas diffusion layer 21 covers the internal edge 134 of the reinforcement 131. The internal edge 134 of the reinforcement 131 therefore gets housed in the recess 211 of the gas diffusion layer 21. The gas diffusion layer 22 is placed in contact with the uncovered part of the anode 112 through the aperture 133. The periphery of the gas diffusion layer 22 covers the internal border 134 of the reinforcement 132. The internal border 134 of the reinforcement 132 therefore gets housed in the recess 211 of the gas diffusion layer 22.

To obtain the cell of a fuel cell 1 illustrated in FIG. 1, the membrane/electrode assembly provided with gas diffusion layers 21 and 22 can then be included between two flow-guiding metal plates 101 and 102.

A recess 211 can be formed by using known methods for forming filigree patterns in paper pulp. A gas diffusion layer comprising a recess 211 in filigree form can especially be obtained by wet process. FIG. 9 is a schematic view in section illustrating a step of an example of a method for the fabrication, by wet process, of a gas diffusion layer comprising a recess 211.

According to such a method using a wet process, an aqueous solution 12 is applied to a porous support 31 having a structure known per se. This support 31 is surmounted by an added-on relief feature 32 (sometimes called a galvano relief or galvano), defining a shape for the recess 211. The combination of a support 31 and an added-on relief 32 for the formation of a gas diffusion layer with recess is illustrated in a top view in FIG. 10. A device 34 for retrieving excess water is positioned beneath the support 31 and includes for example a vacuum suction device. The support 31 is designed to allow the filtering of water included in the aqueous solution 12 to preserve the remainder of the constituents of the solution above this support 31.

The aqueous solution includes carbon fibers (known per se in the formation of gas diffusion layers) and a binder material (for example polyvinyl alcohol). The aqueous solution 12 can take the form of a dispersion including the different elements.

As illustrated in the example, the aqueous solution 12 can for example be applied by means of a spraying nozzle 33 that is mobile relatively to the support 31. In preparation for such an application of the aqueous solution 12, this solution can have a proportion by mass in carbon fibers smaller than or equal to 0.02% (for example equal to 0.01%) during the spraying. The binder material can for example constitute 5 to 10% of the proportion by mass of the gas diffusion layer formed.

Once the aqueous solution 12 is applied to the support 31, the major part of the water from this solution is allowed to get discharged through the support 31 until a material is obtained that is solid enough to enable it to be handled. The solidified element comprises the recess 211 defined by the shape of the relief 32. The solidified element can then undergo other processing operations such as oven drying, pressing, impregnation or graphitization, until a gas diffusion layer 21 that must be assembled inside the fuel cell 1 is obtained.

The solidified element can have a recess depth greater than that of the formed gas diffusion layer, especially when the solidified element undergoes a pressing step. The thickness of the relief feature 32 will advantageously be defined to take account of these subsequent steps of the process. The width of the relief will advantageously range from 500 μm to 3000 μm in order to define the width of the recess 211 to be formed.

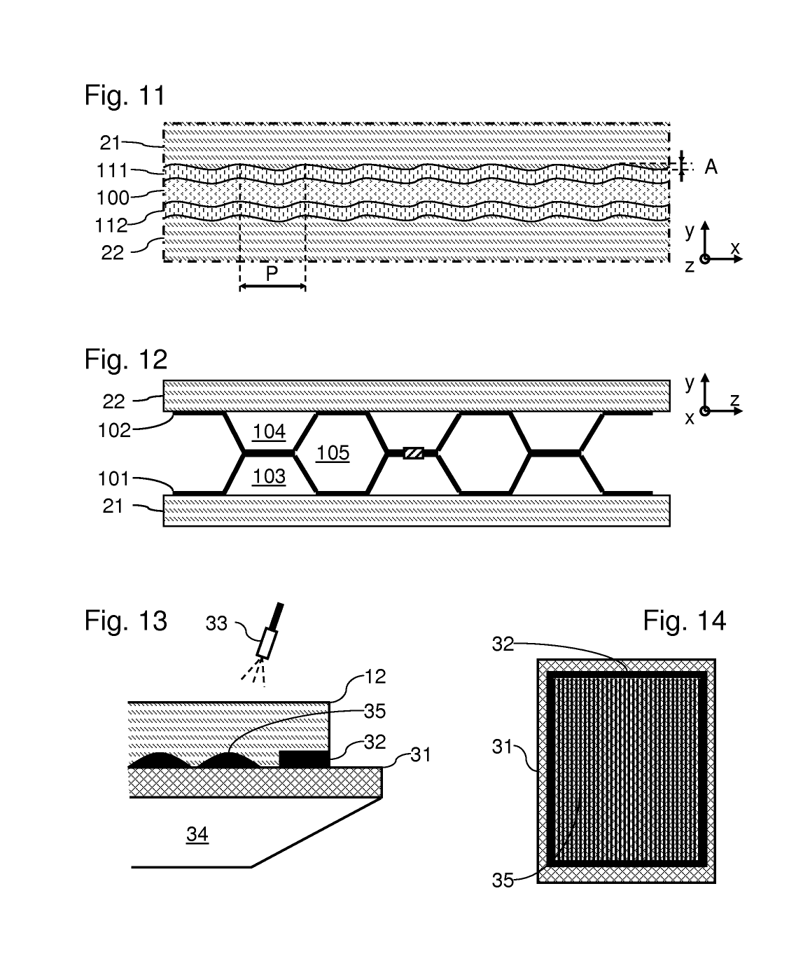

FIG. 11 is a schematic view (in cross section) of another embodiment of fuel cell 1, focusing on the membrane/electrode assembly. The contact interfaces between the gas diffusion layers 21 and 22 and the cathode 111 and the anode 112 respectively are wave-shaped.

For that purpose, the face of the gas diffusion layer 21 in contact with the cathode 111 is wave-shaped. Similarly, the face of contact of the gas diffusion layer 22 with the anode 112 is wave-shaped. The membrane/electrode assembly is flexible and is wave-shaped by the gas diffusion layers 21 and 22.

Thus, with a slightly increased thickness of the electrochemical cell and with a same area of the guiding plates 101 and 102, the exchange area between the gas diffusion layers 21, 22 and the electrodes 111, 112 is increased. Such a fuel cell 1 has an increased power with an almost unchanged volume. An increase power is obtained with an unchanged volume of the gas diffusion layers. The cost of the gas diffusion layers (generally the most expensive parts of the fuel cell) is almost unchanged.

In the example of FIG. 11, the wave shape has a period P along the x direction. Period P is advantageously comprised between 50 and 250 μm, and preferably between 75 and 150 μm (for instance 100 μm). Period P is low enough to obtain a contact area increase without increasing the thickness of the membrane/electrode assembly. Period P is high enough to avoid excessive deformations of the membrane/electrode assembly. The fastening between electrodes 111, 112 and the membrane 100 is thereby not altered. The contact between the electrodes and their respective gas diffusion layers is also maintained.

The wave shape has advantageously a homogeneous height A. This height is advantageously comprised between 15 and 50 μm, and preferably between 20 and 45 μm. This height is preferably comprised between 5 and 20% of the thickness of the gas diffusion layer, and preferably comprised between 5 and 15%. Height A is the depth between the top and the bottom of the wave shape. Height A is high enough to significantly increase the exchange area between a gas diffusion layer and its respective electrode. Height A is low enough to avoid excessive deformations of the membrane/electrode assembly. The ration between period P and height A is preferably comprised between 2 and 5. Gas diffusion layers 21 and 22 have preferably a thickness comprised between 150 μm and 500 μm, and preferably comprised between 200 and 300 μm.

With such parameters, the exchange area between a gas diffusion layer and its respective electrode can be increased (between 10% and 25%).

The wave shape has preferably no sharp edge and has preferably a high radius of curvature. The membrane/electrode assembly is thereby not altered. A homogenous contact between an electrode and its gas diffusion layer is maintained as well. The contact face between an electrode and its gas diffusion layer has preferably an extrusion shape.

The membrane/electrode assembly can be easily shaped without being altered, when its thickness is comprised between 35 and 130 μm. The thickness of electrodes 111 and 112 is preferably comprised between 5 and 15 μm. The thickness of the membrane 100 is preferably comprised between 20 and 100 μm.

FIGS. 13 and 14 illustrate another embodiment of the fabrication step illustrated at FIGS. 9 and 10. During this step, a gas diffusion layer having a wave-shaped contact surface is obtained by wet process. The support 31 is additionally surmounted by an added-on relief feature 35, defining the wave shape in the middle portion of the gas diffusion layer. The relief feature 35 defines recesses in the middle portion of the gas diffusion layer with an appropriate wave shape.

The gas diffusion layer obtained by such a wet process step has a flat upper surface.

1. A method for fabricating a fuel cell, said method comprising fixedly attaching a reinforcement to a proton-exchange membrane and to an electrode placed against a first face of said proton-exchange membrane, said reinforcement having a median aperture through which an interior portion of said electrode is exposed, wherein fixedly attaching said reinforcement comprises superimposing an inner edge of said reinforcement over a periphery of said electrode, and causing a projecting portion of said reinforcement to project said proton-exchange membrane so as to limit gas permeation into said proton-exchange membrane, forming filigrees by a wet process in a gas diffusion layer, thereby forming a recess therein, and placing said gas diffusion layer so that said inner edge of said reinforcement extends into said recess in said gas diffusion layer.

2. The method of claim 1, wherein forming filigrees comprises applying layer of an aqueous solution including carbon fibers and a binding material, and solidifying components of said aqueous solution to form said gas diffusion layer.

3. The method of claim 2, wherein said gas diffusion layer formed comprises a recess having a depth between 25 μm and 75 μm.

4. The method of claim 2, wherein said gas diffusion layer formed comprises a recess having a width between 500 μm and 3000 μm.

5. The method of claim 1, wherein said gas diffusion layer placed has a substantially homogenous composition.

6. The method of claim 1, wherein said gas diffusion layer comprises a first face, in which said recess is formed, and a second face, wherein a part of said second face that is disposed over said recess is in alignment with a median part of said second face.

7. A method for fabricating a fuel cell, said method comprising fixedly attaching a reinforcement, said reinforcement having an aperture in a median part thereof, to a proton-exchange membrane and to an electrode placed against one face of said proton-exchange membrane, so that an inner edge of said fixedly attached reinforcement covers a periphery of said electrode, with a projection onto said proton-exchange membrane, forming a recess on a periphery of a gas diffusion layer by forming filigrees by a wet process in said gas diffusion layer, and placing said gas diffusion layer so that said recess is positioned plumb with said inner edge of said reinforcement.

8. The method of claim 7, wherein forming filigrees comprises applying layer of an aqueous solution including carbon fibers and a binding material, and solidifying components of said aqueous solution to form said gas diffusion layer.

9. The method of claim 8, wherein said gas diffusion layer formed comprises a recess having a depth between 25 μm and 75 μm.

10. The method of claim 8, wherein said gas diffusion layer formed comprises a recess having a width between 500 μm and 3000 μm.

11. The method of claim 7, wherein said gas diffusion layer placed has a substantially homogenous composition.

12. The method of claim 7, wherein said gas diffusion layer comprises a first face, in which said recess is formed, and a second face, wherein a part of said second face that is plumb with said recess is in the alignment with a median part of said second face.
